(19) United States
(12) Patent Application Publication
(10) Pub. No.: US 2005/0124786 A1
(43) Pub. Date: Jun. 9, 2005

(54) Films with crater-shaped protrusions

(76) Inventors: James Sinclair Sharp, Nottingham (GB); Richard Jones, Sheffield (GB)

Correspondence Address: WHITE & CASE LLP;PATENT DEPARTMENT, 1155 AVENUE OF THE AMERICAS, NEW YORK, NY, 10036, US

(21) Appl. No.: 10/498,438

(22) PCT Filed: Dec. 11, 2002
(86) PCT No.: PCT/GB02/05605

(30) Foreign Application Priority Data
Dec. 11, 2001 (GB) 0129547.6

(51) Int. Cl. C08G 2/00; C08F 6/00

(52) U.S. Cl. 528/491; 528/502 R

(57) ABSTRACT

Polymer films having a number of wells can be prepared by contacting the polymer with a solvent which causes the polymer film to swell and produce blisters. When the film is dried the blisters collapse to form wells. The polymer film is supported on a substrate such as silica or glass and the wells are often arranged in an array. An example of a polymer which can be used is poly(d,l-lactide).

This invention relates to a method of preparing polymer films having wells and to the films produced.

Materials having wells have found a number of applications, particularly where the wells are present in the form of an array. Examples, include the use of these wells to contain chemicals used in high throughput screening to identify properties of the chemical compounds contained in the wells. This application is particularly important in the pharmaceutical industry. They may also be used to grow tissues, such as mammalian tissues.

One way of preparing materials having wells is to attach a polymer film to a substrate and cause wells to form in the polymer film. This process presents many technical challenges.

Many of the current and future technological challenges involve the patterning of a surface on a length scale of microns or less; this might be, for example, to achieve a desired optical effect, or to provide a controlled substrate for tissue growth. One class of methods for achieving such patterning relies on a physical instability with an intrinsic lengthscale. This provides a means of producing ordered structures from initially disordered systems whose characteristic lengthscale is controlled by simply making small changes in the experimental conditions, removing the need for the use of direct surface patterning techniques such lithography and contact printing.

Examples of such processes include dewetting and buckling produced by stresses arising from dispersion forces or residual mechanical stress. The typical morphology produced by these instabilities consists of surface corrugations or wrinkles.

We have now found that another buckling instability that arises following the osmotically driven swelling of a polymer film can be used to produce wells in a polymer film.

According to the present invention there is provided a method of preparing a polymer film having a plurality of wells, said method comprising contacting a polymer supported on a substrate with a solvent which causes the polymer film to swell thereby forming blisters, and drying the polymer film so that the blisters collapse to form wells.

The wells preferably form an array. The morphology may be orientated by rubbing the substrate prior to application of the polymer film. One way of achieving this is to rub the substrate with a cylindrical velvet coated roller which may be rotated using a DC motor.

It is generally preferred that the wells have a depth of 10 to 100 nm deep. It is generally preferred that the wells have a diameter of several microns, for example 0.5 to 10 μm (especially 0.5 to 5 μm).

Polymer films of particular interest include those formed from biodegradable polymers. An example of a polymer of particular interest is an aliphatic polyester, such as poly(d,l-lactide). A specific example if a low molecular weight (eg about 12 KDa) poly(d,l-lactide).

The polymer film is generally an ultra thin film. Examples include polymer films of 22 to 300 nm thickness. The polymer film may be applied to the substrate by conventional techniques such as by spin coating the polymer from a solution onto the substrate, followed by annealing. Examples of suitable substrates include inert materials such as glass or silicon. In general we have found that a thicker polymer film allows deeper wells to be produced Therefore, the thickness of the polymer film may be selected so as to allow production of wells of the desired depth. This may be explained by the fact that as the thickness of the film is increased, so is its resistance to bending. For a given shape, a thicker film will have more energy stored in it. Therefore, for a given strain energy per unit volume we have found that thicker films are able to store more of the energy released by buckling into a structure which has a larger radius of curvature and therefore a lengthscale of larger value.

When the solvent is brought into contact with the polymer film, it causes the polymer to swell. In general, the solvent is selected such that it causes the polymer to swell rather than dissolve the polymer. In general, a non-organic solvent is preferred such as water.

The solvent is contacted with the polymer film for sufficient time to allow the polymer film to buckle and produce blisters; and for a time sufficient to form a well of the desired depth following drying of the polymer film and collapse of the blister.

The temperature of the solvent is selected so that a well of the desired diameter and depth is produced. In general, increasing the temperature gives rise wells of smaller diameter. An increase in temperature also tends to give rise to a deeper well. Thus, in a preferred embodiment, the temperature of the solvent is controlled so as to give wells of the desired diameter and depth.

The present invention also includes a polymer film as described above and in particular a polymer film obtained by the method described above.

Thus, particular embodiments include the following.

A polymer film supported on a substrate, wherein the polymer film has a plurality of wells of diameter 0.5 to 10 μm (especially 0.5 to 5 μm).

A polymer film supported on a substrate, wherein the polymer film has a plurality of wells in the form of an array and the polymer film comprises poly(d,l-lactide).

A polymer film supported on a substrate, wherein the polymer film has a plurality of wells in the form of an array, the polymer film comprises poly(d,l-lactide) and the wells are of diameter 0.5 to 10 μm (especially 0.5 to 5 μm) and 10 to 100 nm deep.

We believe that the wells occur as the result of an osmotically driven blistering process, which takes place when ultrathin films of a polymer are immersed in a solvent. When a polymer is immersed in poor solvent, instead of dissolving, it will swell, because of the osmotic pressure introduced by the association of the small solvent molecules with the polymer segments. If the film is prevented from swelling, for example by confining it on a substrate, then it will be left in a state of strain. To completely release this strain energy the film has to increase its volume and if the film is confined laterally, this can only be done if the film bends. So, when the stresses in the film exceed some critical value, it is possible for the film to release its strain energy by buckling to form a blister. If the size of the lateral confinement region remains constant, then in the absence of any other processes this will result in as short a wavelength being produced as is required to completely release the strain energy in the film. However, the bending of the film also introduces stresses and the greater the amount of bending that occurs the more bending energy is required. Reduction of the bending energy therefore favours a long wavelength and if the wavelength preferred by the release of strain energy would result in an increase in the bending energy that is greater than the amount of energy available to buckle the structure, then by simple conservation of energy arguments this cannot occur. To get around this restriction the system has to buckle with a wavelength which corresponds to a balance between the strain energy in the unbuckled film and the bending energy introduced by buckling.

The invention will now be further described with reference to the accompanying Examples and Figures.

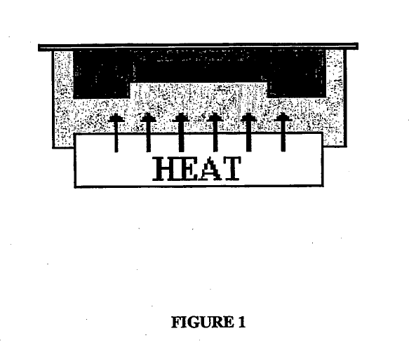

FIG. 1. The water bath used for swelling the polymer films at constant temperature, consists of a piece of Aluminium machined to fit on top of a Linkam Hotstage, which can be filled with water and covered with a glass cover slip. A T type thermocouple is used to measure the temperature of the water.

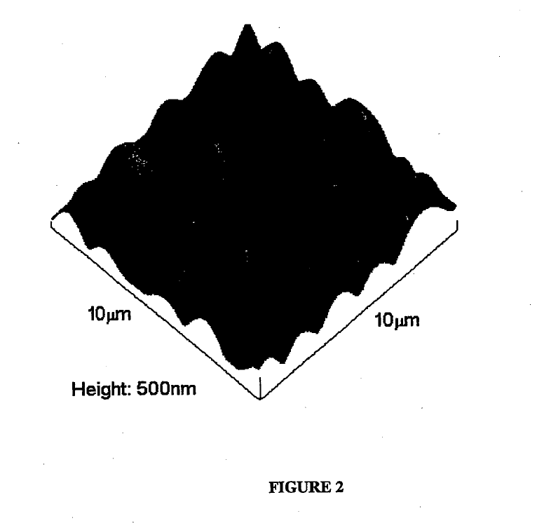

FIG. 2. Samples immersed in water at 40° C. buckle away from the substrate to form blisters. These blisters grow and coalesce until they reach a maximum size. An AFM image is shown for a 150 nm thick film (size 10×10 microns; height 500 nm) that has been immersed for 5 minutes.

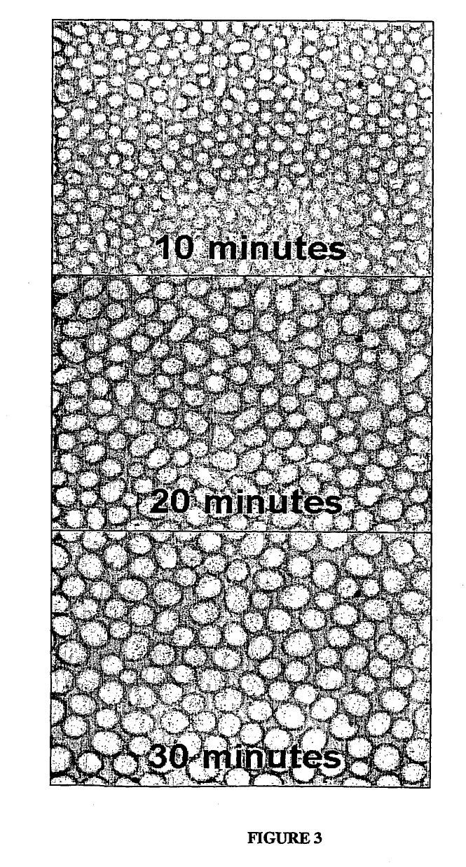

FIG. 3. Samples immersed in water for different times, removed and dried, show how the blisters grow. Optical micrographs are shown for 200 nm films immersed in water at 40° C. for a) 10 minutes b) 20 minutes and c) 30 minutes.

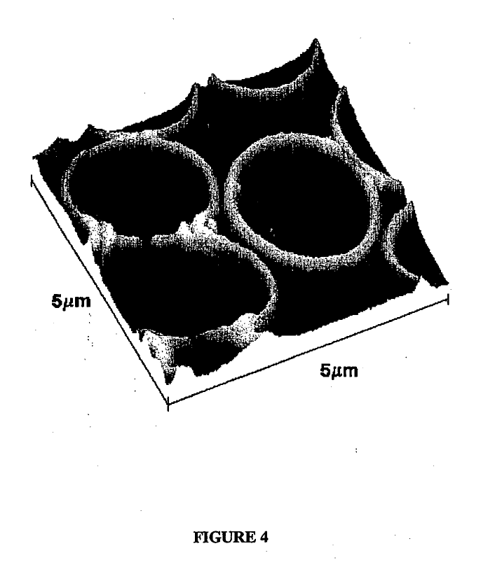

FIG. 4. Removing the films from water causes the blisters to collapse and form craters. As the polymer collapses back to the substrate, it wrinkles producing the rings shown in the image in this figure.

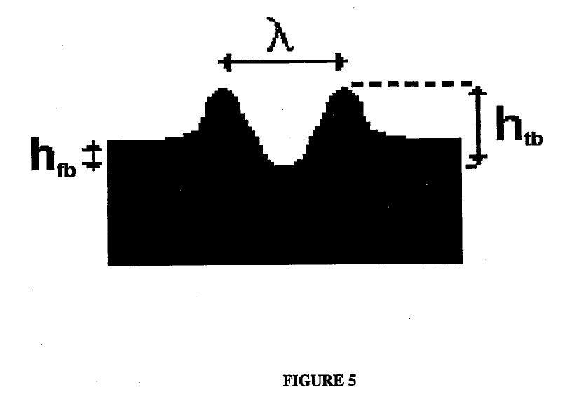

FIG. 5. Measurements of the diameter and depth of the craters were taken using an optical microscope and an Atomic Force Microscope

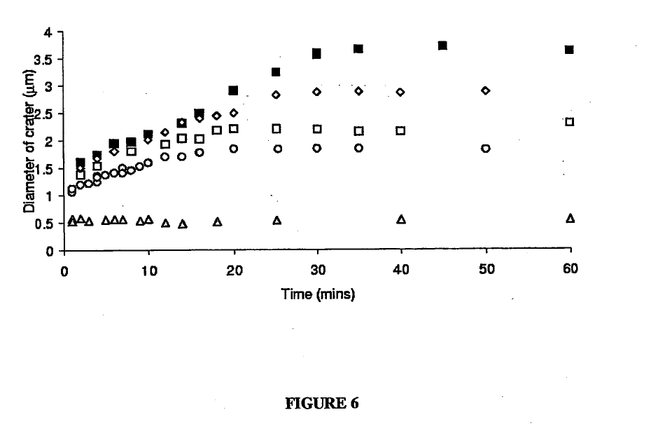

FIG. 6. Crater growth curves. Data is shown for films immersed in water at 40° C. The film thicknesses shown are (Δ) 50 nm, (◯) 100 nm, ( ) 150 nm, (⋄) 190 nm, (▪) 200 nm.

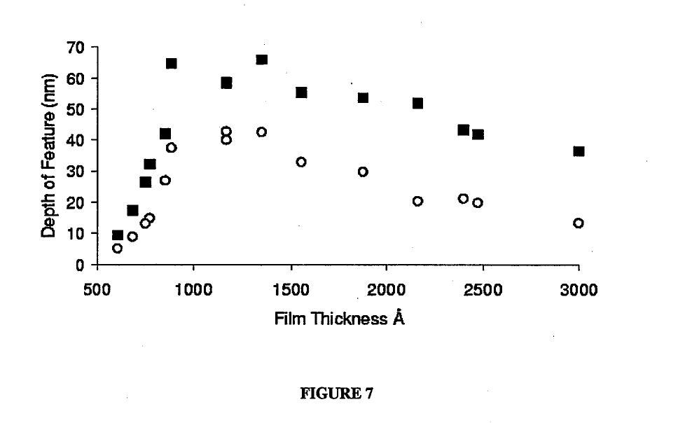

FIG. 7. Variation of depth of craters with film thickness for films immersed in water at 40° C. for 5 minutes. Data is shown for both the crater base-to-top distance, h_{tb} (▪)) and the film-to-base distance h_{fb} (◯).

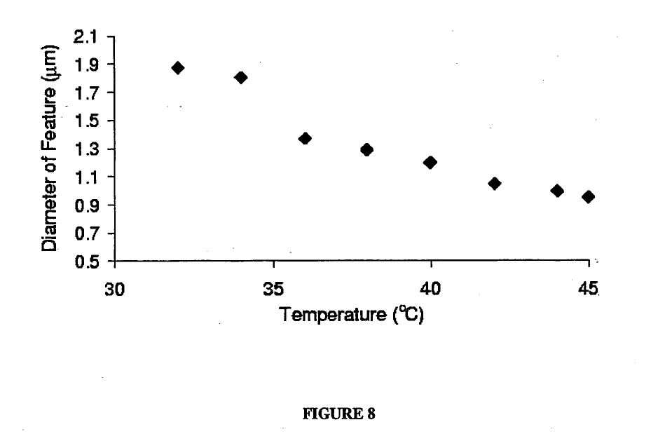

FIG. 8. Temperature dependence of crater diameter. As the temperature increases a reduction in the crater diameter is observed. Data is shown for 90 nm films that have been immersed in water for 5 mins for both the crater base-to-top distance, h_{tb} (▪), and the film-to-base distance, h_{fb} (◯).

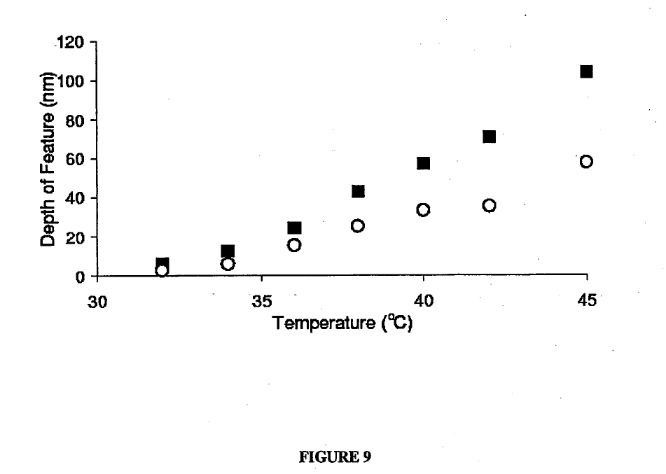

FIG. 9. Swelling stresses in the buckled part of the film cause the polymer to flow and thin. Increasing the temperature reduces the viscosity of the polymer, so that a greater amount of thinning occurs for a given stress. The result is a deeper crater when the blisters collapse. Data is shown for 90 nm films that have been immersed in water for 5 mins.

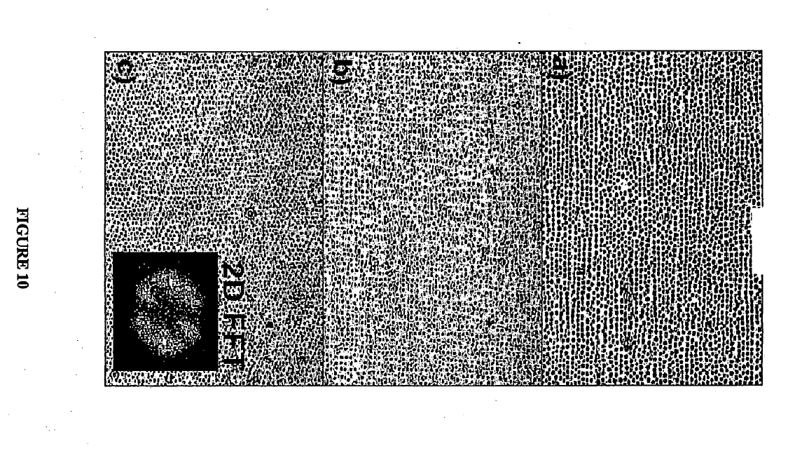

FIG. 10. Orientation of the morphology is possible. This is achieved by rubbing the substrate prior to spin coating the polymer films. Data is shown for a) lines b) squares and c) hexagonally packed arrays.

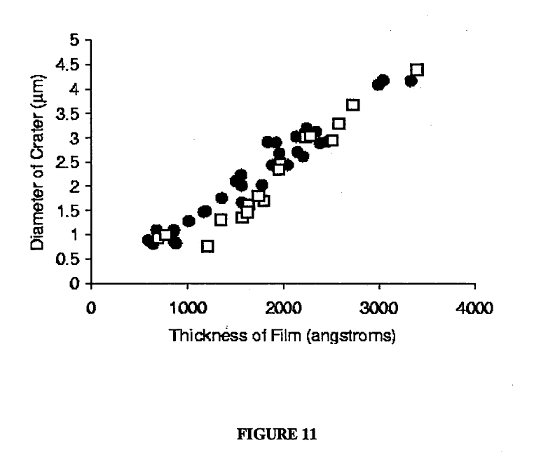

FIG. 11. Orientation of the morphology does not change the blistering length λ. Data is shown for un oriented samples (●) and samples showing the line morphology ( ).

The polymer used in this study was a low molecular weight (12 KDa) polyester, called poly (d,l lactide) (PLA). Supported films were made by spin coating the polymer from solutions in chloroform on to 1 cm2 substrates of single crystal silicon and annealing at 40° C. for 1 hour. The silicon used was obtained from Compart technology and had been cleaved parallel to the [100] axis. Each substrate had a natural oxide coating that was typically 1.8 nm thick. The polymer was obtained from AstraZeneca (UK) Ltd. The thickness of the polymer films was measured using ellipsometry. The range of thicknesses studied was 22-300 nm. Roughness measurements were also taken on the annealed films using the AFM and the r.m.s. roughness typically found to be 0.5 nm.

After annealing, the supported polymer films were placed individually into a specially constructed water bath. The bath consisted of a piece of aluminium machined so that it could be mounted onto a Linkam hotstage (see figure \ref{waterbath}), filled with water and covered with a glass cover slip. The films were immersed for different times at a range of temperatures, so that both kinetic and temperature dependent data could be obtained. A thermocouple was introduced through a hole in the side of the bath, so that the temperature could be measured independently. The temperature stability was found to be +/−1° C. at 40° C. After immersion, the films were removed and gently dried with nitrogen gas.

The samples were imaged using a Nikon Eclipse ME600 optical microscope and a Digital Instruments Multi Mode Atomic Force Microscope with a Nanoscope IIa controller. Both were equipped with image analysis software. This allowed for the measurement of both the lateral dimensions and depths of any surface features. Between 100 and 200 objects were imaged on each sample.

In situ AFM of the sample placed in water at 40° C. showed that the films were blistering away from the substrate (FIG. 2). As time progressed, these blisters grew and coalesced until they reached a maximum diameter. An AFM tip was used to puncture one of the blisters to test if the films were delaminating at the polymer silicon interface. The resulting AFM image showed that the difference in height between the bottom of the ruptured blister and the top of the unblistered parts of the film was equal to the film thickness. This indicates that failure of the polymer silicon interface is occuring during blister production and that internal failure of the polymer film is not taking place.

Samples that had been immersed in water and removed were observed to be covered with a monodisperse distribution of craters. The optical microscope, equipped with Image-Pro plus software (Media Cybernetics), was used to measure the size of the features (FIG. 3) and some of the samples were also imaged using the AFM (FIG. 4). The measurements taken are shown in FIG. 5}. These include the blistering length, λ, the distance between the top of the crater and its base, h_{tb} and the distance between the top surface of the film and the crater base, h_{fb}. In all cases the blisters on the films were observed to be present everywhere on the surface and had collapsed and wrinkled to form craters. When imaged with the AFM, the craters were found to be completely lined with polymer, indicating that rupturing of the blisters does not occur when they are removed from the water.

Growth curves were constructed for the craters by immersing samples of the same thickness in water for different periods of time at 40° C. and imaging them with the optical microscope (see FIG. 6). This was done for films that were 22, 32, 50, 100, 150, 190 and 200 nm thick.

After the initial buckling, the driving force for blister growth arises because there are still areas of the film which remain attached to the substrate and which are still in a state of strain. Growth of the blister releases some of this strain energy, but also creates more surface. This requires that work be done to overcome the adhesive forces between the film and substrate. Local bending stresses in the blistered part of the film can be considered small except at the crack tip where the film is still attached to the substrate. Here the stresses are quite high and allow the crack tip to propagate and produce more free surface. For the most part the contributions from the buckled part of the film can be neglected except to say that the crack tip is allowed to propagate because of these stress concentrations.

Temperature dependent studies were also performed. These involved immersing 90 nm thick films in water at various temperatures for 5 minutes. Each sample was then measured on the microscope (FIG. 8). The data shows that as the temperature of the water and sample are increased, the size of the blisters decreases.

This is may be explained as follows. An increase in temperature in this material causes an increase in the equilibrium volume fraction of water and a corresponding increase in the in-plane swelling strain. This allows the film to buckle with greater amounts of curvature and pushes the blistering length to smaller values.

As well as measuring the diameter of the craters, an AFM was used to image the topology of the samples. This revealed that the craters were typically 10-100 nm deep and that the depth of the crater could be controlled by changing the film thickness. The crater depth as a function of film thickness for samples immersed in water at 40° C. for 5 minutes is shown in FIG. 7. The two quantities plotted in this graph, represent the distance between the top of the crater and the base, htb, and the distance between the top surface of the undetached areas of the film and the base of the crater, hfb. This second quantity is non zero indicating that the detached parts of the film experience some viscous flow and that thinning of the film occurs. So that when the films are removed from the water, the blistered part collapses back down to produce a crater that extends below the top surface of the film.

As the temperature of the water is increased, the viscosity of the hydrated film is expected to decrease. This means that the application of a swelling stress will cause more flow in the buckled material and will result in a larger amount of thinning of the buckled part of the film as stress is dissipated. The net result, for a given film thickness is a deeper crater (FIG. 9).

It is possible to orient the morphology by rubbing the substrate prior to spin casting of the film. The rubbing described here was performed using a cylindrical velvet coated roller attached to a D.C motor.

The orientations achieved are shown in FIG. 10. The line morphology was obtained by simply rubbing the substrate in one direction, the squares by rubbing in two orthogonal directions and the hexagons by rubbing the substrate twice with a 60° C. angle between the rubbing directions. Of the three types of morphology, the most technologically interesting are the lines and square arrays. These structures clearly show long range order while the hexagonal ordering decays over much shorter distances.

There is no change in crater size due to the effects of rubbing the substrate (see FIG. 11), instead it is believed that rubbing simply introduces some anisotropy into the adhesive properties of the substrate.

The swelling of a polymer film confined by a substrate can lead to an osmotically driven blistering process. These blisters form with some characteristic blistering length, λ, which is controlled by a balance between the membrane stresses in the film, the bending stresses in the blistered film and the adhesion between the film and the substrate. The membrane stresses in the system are caused by the swelling of the confined film and the resulting strain can be written in terms of the equilibrium volume fraction of solvent in the polymer. In this study, the swelling strain resulted in blistering on the micron length scale. The removal of the blisters from water results in their collapse to produce a monodisperse distribution of craters that are microns in diameter and which are between 10 and 100 nm deep.

It is possible to align these craters by simply rubbing the substrate before the polymer film is deposited. There is no apparent change in the crater dimensions due to this process and it is believed to occur simply as a result of anisotropic adhesion caused by the modification of the substrate by the rubbing process. The ability to align monodisperse objects, that self assemble with dimensions in the micron and tens of nanometres ranges is potentially very exciting for a number of applications.

The theories used to describe blister formation and growth indicate that this phenomenon should be observable in other systems. This would involve finding the correct polymer/solvent/substrate system. In this study, the equilibrium solvent volume fraction in the polymer was shown to influence the initial swelling strain in the films and the viscosity of the polymer. These are the physical properties that are responsible for controlling the initial blistering length, and the growth time, of the blisters respectively. The solvent volume fraction can be controlled because for a given polymer a suitable solvent can usually be found that swells the polymer by the required amount to produce the strain required. The parameter which requires more attention is the energetics of the surface interaction between the swollen polymer and the substrate. This determines if the polymer will detach from the substrate and if the resulting blisters will grow. By choosing a system where the surface interaction can be tuned, these structures can be produced using more ‘processing friendly’ materials.

1. A method for preparing a polymer film having a plurality of wells, the method comprising the steps of:
contacting a polymer film supported on a substrate with a solvent which causes the polymer film to swell and thereby form blisters; and
drying the polymer film to cause the blisters to collapse to form wells.

2. The method according to claim 1, wherein the wells form an array.

3. The method according to claim 1, further comprising the step of rubbing the substrate prior to application of the polymer film to the substrate to orient the morphology of the wells produced.

4. The method according to claim 1, wherein the wells have a depth of 10 to 100 nm.

5. The method according to claim 1, wherein the polymer film has a plurality of wells having a diameter in the range of about 0.5 to about 10 μm.

6. The method according to claim 1, wherein the polymer is a poly(d,l-lactide).

7. The method according to claim 1, wherein the thickness of the polymer film is in the range of about 22 to about 300 nm.

8. The method according to claim 1, wherein the substrate is glass or silicon.

9. The method according to claim 1, wherein the solvent is water.

10. The method according to claim 1, wherein the polymer film is contacted with the solvent for a sufficient time to allow the polymer film to buckle and thereby produce the blisters and for a time sufficient to form a well of the desired depth following drying of the polymer film and collapse of the blister.

11. The method according to claim 10, wherein the temperature of the solvent is adjusted to give wells of having a desired diameter and depth.

12. A polymer film obtained by the method according to any one of claims 1 to 11 and 16-17.

13. A polymer film supported on a substrate, wherein the polymer film has a plurality of wells having a diameter in the range of about 0.5 to about 10 μm.

14. A polymer film supported on a substrate, wherein the polymer film has a plurality of wells in the form of an array and the polymer film comprises poly(d,l-lactide).

15. The polymer film supported on a substrate according to claim 14, wherein the wells have a diameter in the range of about 0.5 to about 10 μm and a depth in the range of about 10 to about 100 nm.

16. The method according to claim 5, wherein the polymer film has a plurality of wells having a diameter in the range of about 0.5 to about 5 μm.

17. The polymer film according to claim 13, wherein the polymer film has a plurality of wells having a diameter in the range of about 0.5 to about 5 μm.

18. The polymer film according to claim 15, wherein the polymer film has a plurality of wells having a diameter in the range of about 0.5 to about 5 μm.
